(19) United States
(12) Patent Application Publication
(10) Pub. No.: US 2005/0061800 A1
(43) Pub. Date: Mar. 24, 2005

(54) Heat convention glass bottle with decorations and wax

(76) Inventors: Wen Cheng Cho, Tau Yuan Hsien (TW); Ming Tsung Cho, Tau Yuan Hsien (TW); Ming Yi Cho, Tau Yuan Hsien (TW)

Correspondence Address: WEN CHENG CHO, 235 Chung - Ho, Box 8-24, Taipei, TW

(21) Appl. No.: 10/730,317

(22) Filed: Dec. 4, 2003

(30) Foreign Application Priority Data
Sep. 22, 2003 (TW) 92216946

(51) Int. Cl. H05B 3/06

(52) U.S. Cl. 219/520; 219/433

(57) ABSTRACT

A heat convention glass bottle with decorations and wax comprises a bottle body made of transparent glass and has a ball-like shape; the bottle body being a hollow body; sterile liquid, wax and first decorations being received in the bottle body, the decorations being mixed into the wax; a bottom of the bottle body being combined with the bottle seat; a bottle seat installed at the bottom of the bottle body for sealing the bottom of the bottle body; a sealing ring being installed between the bottom of the bottle body and the bottle seat; liquid soft glue being filled above the sealing ring; a heat tolerable film adhered to a top of the bottle seat; the heat tolerable film having a through hole; and a base around a bottom of the heating device.

### FIELD OF THE INVENTION

The present invention relates to glass bottles, and particular to a heat convention glass bottle with decorations and wax which can presents beautiful visual effect.

### BACKGROUND OF THE INVENTION

In the prior art glass water bottle with decorating effect, colorful sterile liquid and decorations are placed in a transparent and hollow bottle. A heating seat is placed at the bottom of the bottle. A heat source is installed in the heating seat. The bottle is heated by the radiation of heat source and heat convection of the fluid within the bottle. Thereby, the sterile liquid and decorations in the bottle are unstable and thus move dramatically.

In the glass bottle, generally, the sterile liquid is pure water and the decorations are small pieces (often sparkling pieces made of PVC). Thereby, visual effect is simple and dull.

### SUMMARY OF THE INVENTION

Accordingly, the primary object of the present invention is to provide a heat convention glass bottle with decorations and wax. The glass bottle comprises a bottle body made of transparent glass and has a ball-like shape; the bottle body being a hollow body; sterile liquid, wax and first decorations being received in the bottle body, the decorations being mixed into the wax; a bottom of the bottle body being combined with the bottle seat; a bottle seat installed at the bottom of the bottle body for sealing the bottom of the bottle body; a sealing ring being installed between the bottom of the bottle body and the bottle seat; liquid soft glue being filled above the sealing ring; a heat tolerable film adhered to a top of the bottle seat; the heat tolerable film having a through hole; and a base around a bottom of the heating device.

The various objects and advantages of the present invention will be more readily understood from the following detailed description when read in conjunction with the appended drawing.

### BRIEF DESCRIPTION OF THE DRAWINGS

FIG. 1 is a structure schematic view of the present invention.

FIG. 2 is a structural schematic view showing that a decoration is used to present a beautiful scenery within the glass bottle.

FIG. 3 is a schematic view showing that an electric heating device is used as a heating device in the present invention.

FIG. 4 is a schematic view showing that a buckle is used as a heating device according to the present invention.

FIG. 5 is a structural view showing the heat tolerable film of the present invention.

FIG. 6 is a schematic view showing another embodiment of the present invention.

FIG. 7 is a partial enlarged schematic view of another embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

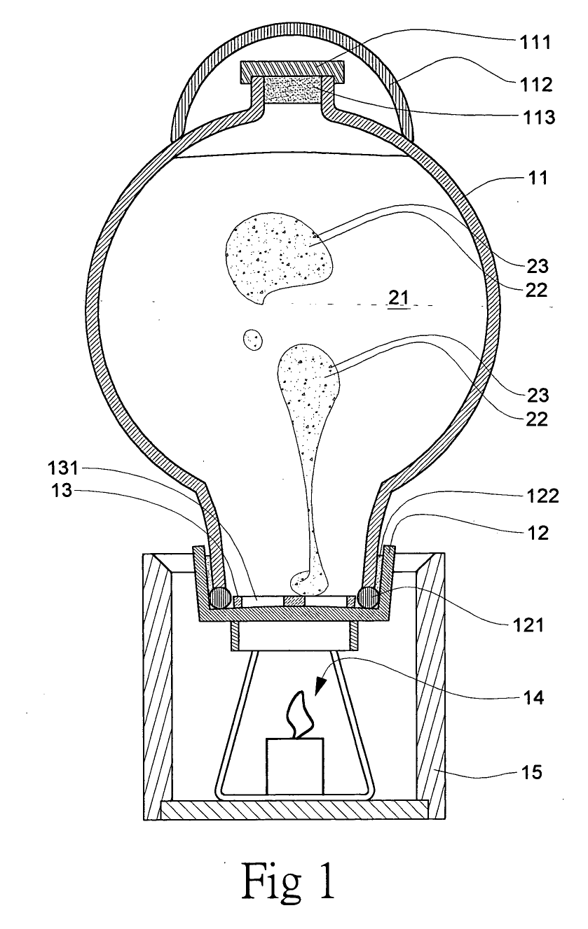

With reference to FIG. 1, a preferred embodiment of the present invention will be described herein.

The heat convention glass bottle with decorations and wax of the present invention includes a bottle body 11, a bottle seat 12, a heat tolerable film 13, a heating device 14, and a base 15.

The bottle body 11 is made of transparent glass and has a ball-like shape. The bottle body 11 has a hollow body. A top of the bottle body 11 has a sealing cover 111, a top cover 112, and a plug 113. Any decoration can be attached to the top cover 112. Sterile liquid 21, wax 22 and decorations 23 are received in the bottle body 11, but they are not fully filled the space in the bottle body 11. Thereby, as the objects within the bottle body 11 are heated, a sufficient space is left for receiving thermal expansion of the objects within the bottom body. In the present invention, the decorations 23 are mixed into the wax 22. A bottom of the bottle body 11 is combined with the bottle seat 12.

The bottle seat 12 is installed at the bottom of the bottle body 11 for sealing the bottom of the bottle body 11. A sealing ring 121 is installed between the bottom of the bottle body 11 and the bottle seat 12. Liquid soft glue 122 is filled above the sealing ring 121. The sealing ring 121 is made of soft glue. Since the sealing ring 121 is between the bottle body 11 and the bottle seat 12. Thereby, by the thermal expansion of the sealing ring 121, the bottle body 11 will not break due to heat expansion or cool contraction.

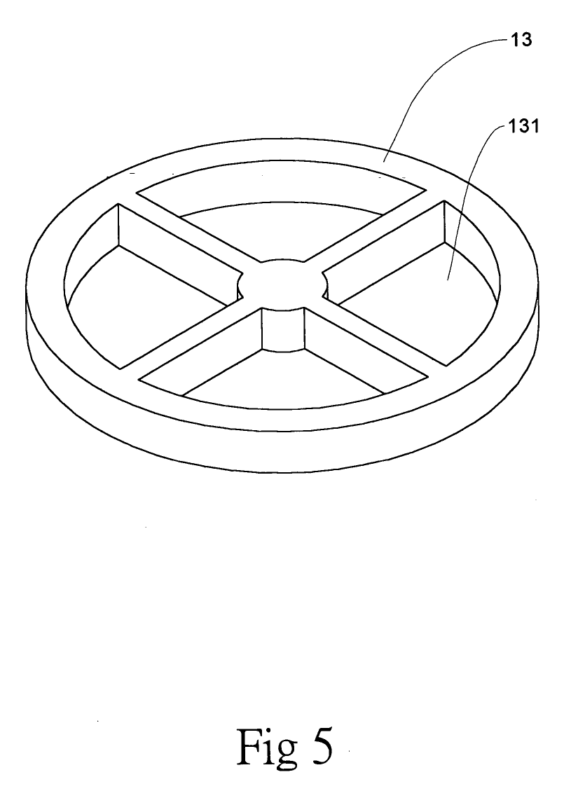

The heat tolerable film 13 can be adhered to the bottle seat 12 by adhesive. The heat tolerable film 13 has a through hole 131 for the radiation of heat or light (referring to FIG. 5).

The heating device 14 may be a candle.

The base 15 is around the heating device 14.

By above structure, the heating device 14 can generate heat, after a time period, the sterile liquid 21, wax 22, and decorations 23 will flow turbulently in the bottle. Since the decorations 23 is mixed in the wax 22, and the wax 22 is mixed in the sterile liquid 21, by the difference of the densities of the objects and the operation of heat convention, the wax 22 with decorations 23 will flow to different elevations and deform so as to present special shape.

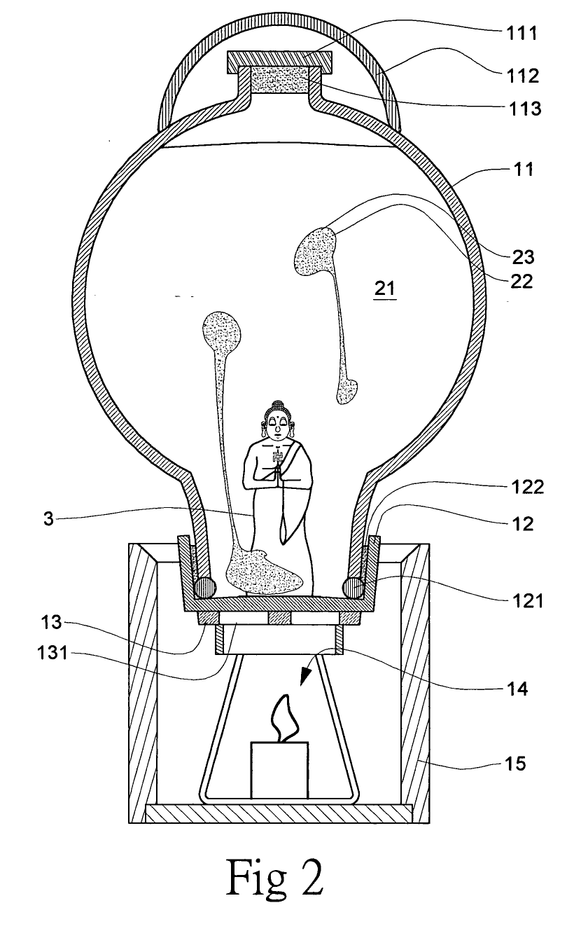

With reference to FIG. 2, any decoration 3 for decorating inner scenery of the bottle can be placed on the bottle seat 12 of the bottle body 11 so as to have a preferred effect. Under this condition, the heat tolerable film 13 is moved from the top of the bottle seat 12 to the lower bottom of the bottle seat 12.

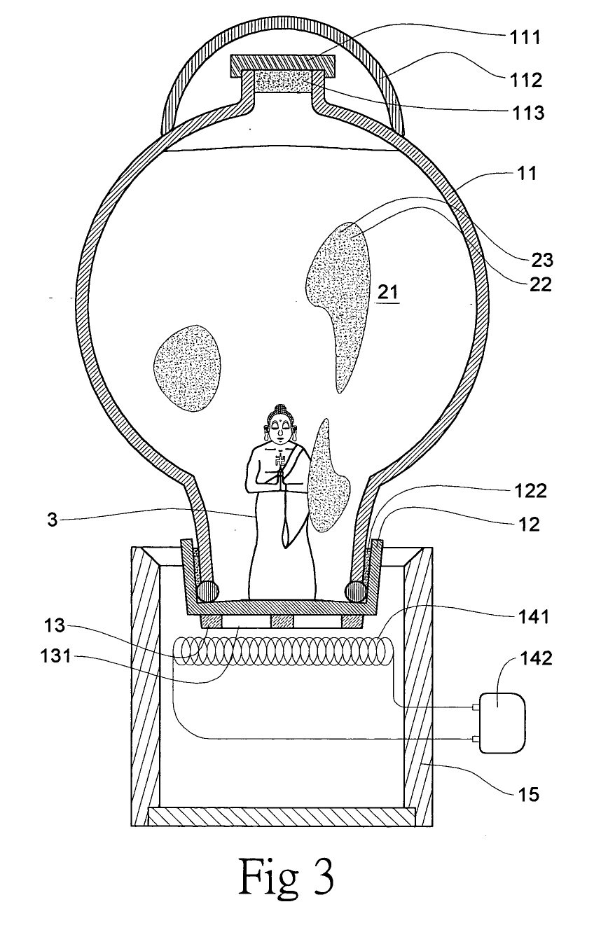

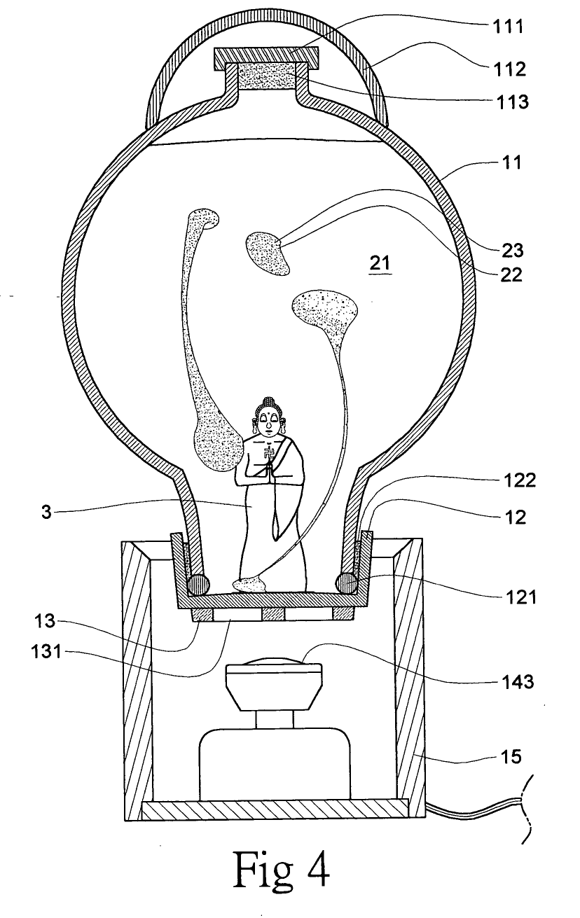

Other than candle, the heating device 14 may be an electric heating device 141, as shown in FIG. 3 so that the temperature is adjustable by a temperature controller 142. As shown in FIG. 4, the heating device 14 can be a bubble 143.

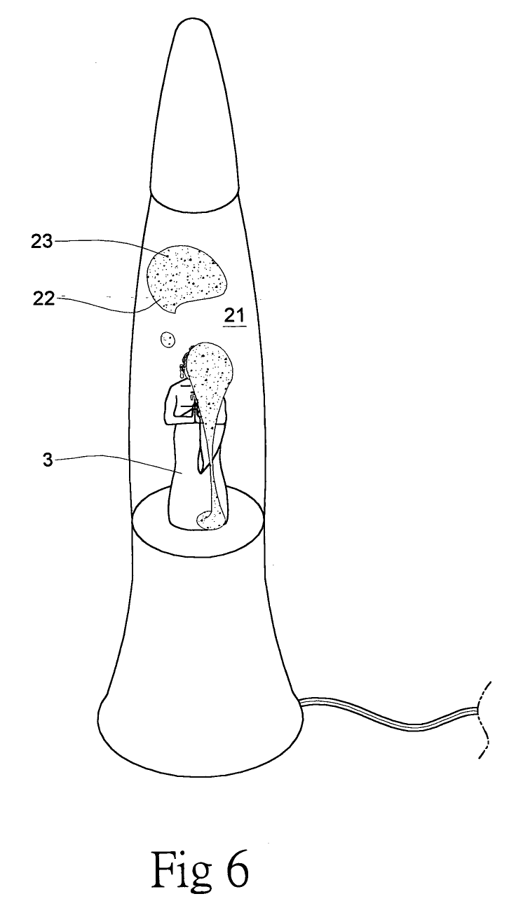

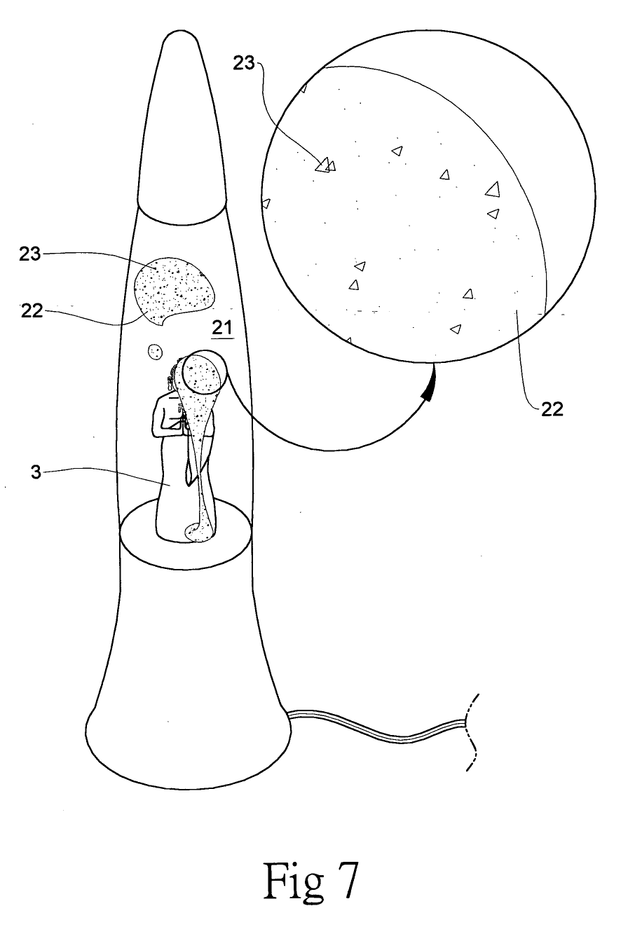

In the present invention, the shape of the heat convention glass bottle with decorations and wax of the present invention can be changed by other shape, as shown in FIGS. 6 and 7 so as to satisfy the requirement of market.

In the present invention, the wax 22 can be ox-hoof oil which has different specific weight and density from those of water.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A heat convention glass bottle with decorations and wax comprising:
a bottle body made of transparent glass and having a ball-like shape; the bottle body being a hollow body; sterile liquid, wax and first decorations being received in the bottle body, the decorations being mixed into the wax; a bottom of the bottle body being combined with the bottle seat;
a bottle seat installed at the bottom of the bottle body for sealing the bottom of the bottle body; a sealing ring being installed between the bottom of the bottle body and the bottle seat; liquid soft glue being filled above the sealing ring;
a heat tolerable film adhered to a top of the bottle seat; the heat tolerable film having a through hole; and
a base around a bottom of the heating device.

2. The heat convention glass bottle with decorations and wax as claimed in claim 1, wherein a top of the bottle body has a sealing cover and a top cover and second decorations are attached to the top cover.

3. The heat convention glass bottle with decorations and wax as claimed in claim 1, wherein the sterile liquid, wax and decorations do not fully fill the bottle body.

4. The heat convention glass bottle with decorations and wax as claimed in claim 1, wherein the heating device is a candle.

5. The heat convention glass bottle with decorations and wax as claimed in claim 1, wherein the heating device is an electric heating device.

6. The heat convention glass bottle with decorations and wax as claimed in claim 1, wherein the heating device is a bubble.
